(19) United States
(12) Patent Application Publication
(10) Pub. No.: US 2011/0063203 A1
(43) Pub. Date: Mar. 17, 2011

(54) Displaying Enhanced Video By Controlling Backlight

(76) Inventor: Sunkwang Hong, Yardley, PA (US)

(21) Appl. No.: 12/558,103

(22) Filed: Sep. 11, 2009

(51) Int. Cl. G09G 3/36

(52) U.S. Cl. 345/102

(57) ABSTRACT

Herein described are at least a method and a system to control the backlight luminance or intensity of a display. The display may be used in a display device such as a television set or computer monitor, for example. The method for controlling the backlight luminance of the display comprises receiving an image contained in one frame of data and generating a histogram of the image, wherein the independent variable of the histogram comprises gray level and the dependent variable of the histogram comprises the number of pixels associated with the gray level, and wherein an average value associated with each of a plurality of gray level intervals of the histogram is used to modulate the luminance of the backlight during a subframe of a plurality of subframes of the one frame. An exemplary system comprises one or more circuits operable for, at least performing the aforementioned method.

### CROSS-REFERENCE TO RELATED APPLICATIONS/INCORPORATION BY REFERENCE

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

As a result of the slow response time of liquid crystals in a liquid crystal display (LCD), video artifacts may be presented in video displayed on a liquid crystal display (LCD). The artifacts may result in video quality that is unacceptable to a viewer.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Various aspects of the invention provide a method and a system of displaying an enhanced video image by way of controlling the backlight of a liquid crystal display (LCD). The various aspects and representative embodiments of the method and system are substantially shown in and/or described in connection with at least one of the following figures, as set forth more completely in the claims.

These and other advantages, aspects, and novel features of the present invention, as well as details of illustrated embodiments, thereof, will be more fully understood from the following description and drawings.

### BRIEF DESCRIPTION OF THE DRAWINGS

FIG. 1 is a system block diagram of a liquid crystal display (LCD) in accordance with an embodiment of the invention.

FIG. 2 is an operational flow diagram of a method of reducing visible artifacts when an image is displayed to a user of a display, in accordance with an embodiment of the invention.

FIG. 3A is a histogram of gray levels based on image data obtained for one frame of data, in accordance with an embodiment of the invention.

FIG. 3B is a graph of a liquid crystal display's (LCD's) response time during a gray level transition as a function of frame time.

### DETAILED DESCRIPTION OF THE INVENTION

Various aspects of the invention can be found in a method and a system of displaying an enhanced and/or improved video image by way of controlling the intensity or luminance of backlight generated by a display. To improve readability of the display, the backlight is used to illuminate the display from the back of the display panel in a liquid crystal display (LCD) television set. By controlling the intensity of the backlight, artifacts which would otherwise be visible, can more readily be concealed from view. The artifacts result from the slow response time of pixels in the liquid crystal display (LCD) of the LCD television set. By using various aspects of the invention, the picture quality (PQ) of an LCD television set, for example, may be improved to a viewer watching a video program. The various aspects of the invention may be used in any display device or appliance which utilizes a liquid crystal display (LCD), plasma display panel (PDP) and/or organic light emitting diode (OLED), as may be found in televisions, laptops, and/or computer displays, for example.

In order to adequately display moving images, the minimum response time of the liquid crystal display should generally be at least smaller than one-half the reciprocal of the display refresh rate. Given high refresh rates at 120 Hz, 240 Hz, or 360 Hz, for example, liquid crystal displays may not provide adequate response times. Consequently, the various aspects of the invention provide for reducing or concealing artifacts resulting from the slow response time of liquid crystal displays.

Various aspects of the invention allow the backlight intensity in a display to be varied by way of modulating a signal such as a pulse width modulated (PWM) signal that is provided at the input of a backlight light source. The backlight generated from the backlight light source may be temporally adjusted within a single frame of video such that the image produced by the display conceals artifacts related to the slow response time of the liquid crystal display (LCD). By way of controlling the backlight within a frame period, response time related artifacts are substantially reduced.

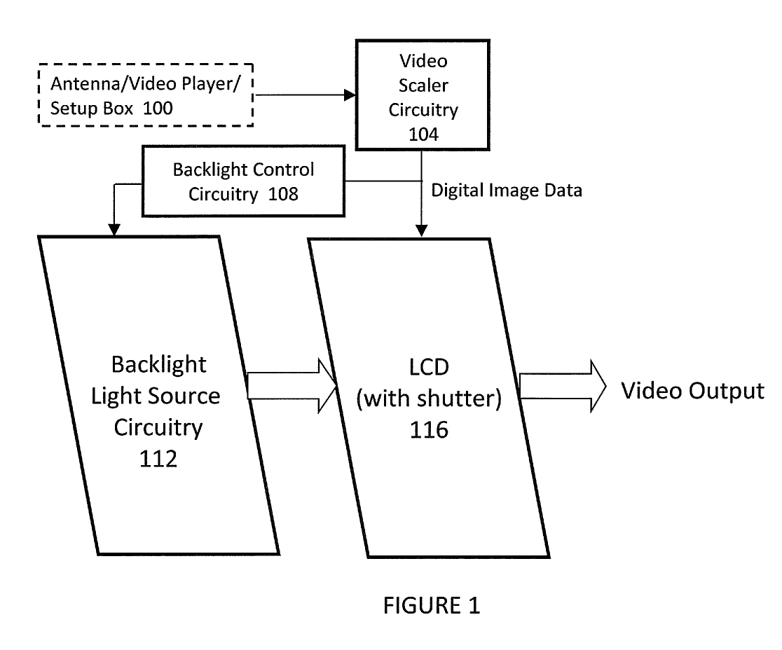

FIG. 1 is a system block diagram of a display in accordance with an embodiment of the invention. The display may comprise an LCD television set or LCD computer display, for example. The display comprises a video scaler 104, a backlight control circuitry 108, backlight light source circuitry 112, and liquid crystal display (LCD) 116. The LCD 116 may comprise an LCD shutter. The video scaler 104 comprises a device for converting video signals from one size or resolution to another. The video scaler 104 receives video data from an antenna/video player/set-top box 100, for example. The video player may comprise a DVD (digital video disc) player or Blu-Ray disc (BD) player, for example. The video scaler 104 outputs image data to the LCD 116 after converting the received video signals. In addition, the video scaler 104 outputs the image data to the backlight control circuitry 108. The backlight control circuitry 108 uses the image data to generate a modulation signal, such as a pulse width modulated (PWM) signal, to the backlight light source circuitry 112. The back light source circuitry 112 may comprise a light source such as CCLF (cold cathode fluorescent lamp) or HCFL (hot cathode fluorescent lamp) or an array of LEDs (light emitting diodes), for example. The duty cycle of the PWM signal is adjusted such that the appropriate backlight level is provided to a subframe of a plurality of subframes within a particular frame period. The duty cycle adjusts or varies the backlight intensity or luminance provided by the backlight light source circuitry 112. The modulation of the modulation signal is determined by way of a histogram, such as a gray level histogram. In a representative embodiment, the histogram is based on image data provided by a single frame of the image data received by the backlight control circuitry 108. The backlight control circuitry 108 generates the histogram based on the image in a frame. The histogram comprises a number of gray level intervals or bins. The backlight control circuitry 108 may temporally divide a frame into an appropriate number of subframes. The backlight luminance associated with each of the subframes may be modulated by the modulation signal. The modulation signal may be generated from the backlight control circuitry 108 and sent to the backlight light source circuitry 112 where the modulation signal is used to effectuate a modulation of the backlight (or backlight intensity/luminance). Thus, the intensity or luminance of the backlight is modulated (or adjusted) for each subframe based on the gray level associated with each subframe. The gray level is based on the corresponding gray level interval from the histogram. The backlight light source circuitry 112 generates a modulated backlight that is combined with the image data provided by the video scaler 104. The resulting output is generated by the LCD 116 for viewing by a viewer.

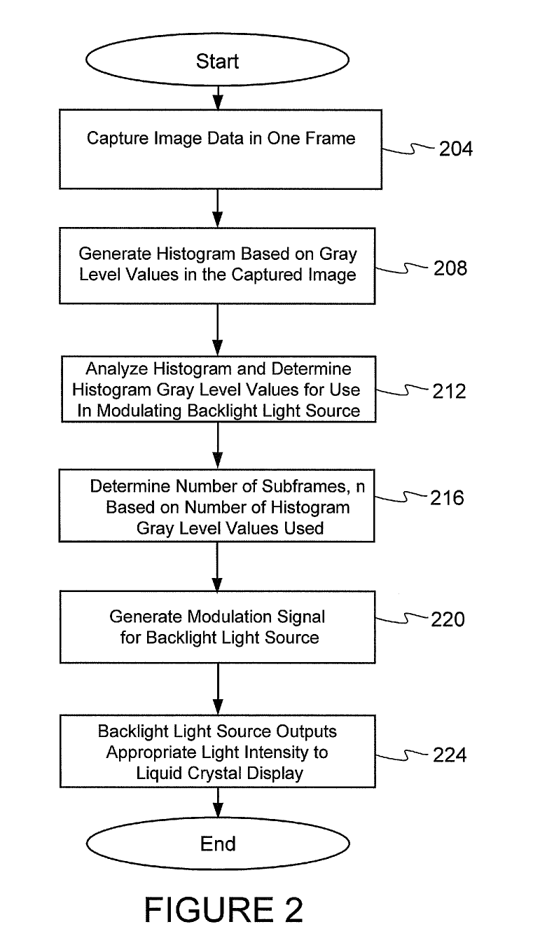

FIG. 2 is an operational flow diagram of a method of reducing visible artifacts when an image is displayed to a user of a display, in accordance with an embodiment of the invention. At step 204, image data is captured for one frame. The image data may be captured by the video scaler and presented to the backlight control circuitry. Next, at step 208, a histogram is generated by the backlight control circuitry based on the image data captured in one frame. In a representative embodiment, the independent variable of the histogram comprises gray level while the dependent variable of the histogram comprises the number of pixels associated with a particular gray level. The number of gray level intervals used in generating the histogram may comprise an integer value greater than 1. The number of gray level intervals used may be configured by a manufacturer of the LCD device or appliance, for example. At step 212, the histogram is analyzed by the backlight control circuitry and the gray levels for those bins or intervals used in modulating the backlight are determined. At step 216, the frame is divided into n subframes. The integer, n, may be determined based on the number of histogram gray level values that will be used by the backlight control circuitry. For example, if all n intervals in the histogram are used, then the frame may be equally divided into n subframes over the frame time (or frame period). The gray level of the nth interval would be used to generate the backlight modulation signal corresponding to the nth subframe. If, in another example, n-2 intervals are used, then the frame may be equally divided into n-2 subframes over the frame time. As the gray level associated with a subframe increases, the modulation signal would modulate the backlight light source circuitry to increase the backlight intensity or luminance output by the backlight light source circuitry. In a representative embodiment, each of the n gray levels associated with the n intervals are used to generate the backlight intensity for each of the corresponding n subframes of the captured frame. At step 220, a signal, such as a pulse width modulated (PWM) signal, whose duty cycle is modulated, is used to modulate the backlight light source circuitry, such that a backlight with appropriate intensity or luminance is generated for the liquid crystal display (LCD). Thereafter, at step 224, the backlight is output by the backlight light source circuitry to the liquid crystal display (LCD) where the backlight is combined to the corresponding video image of the frame.

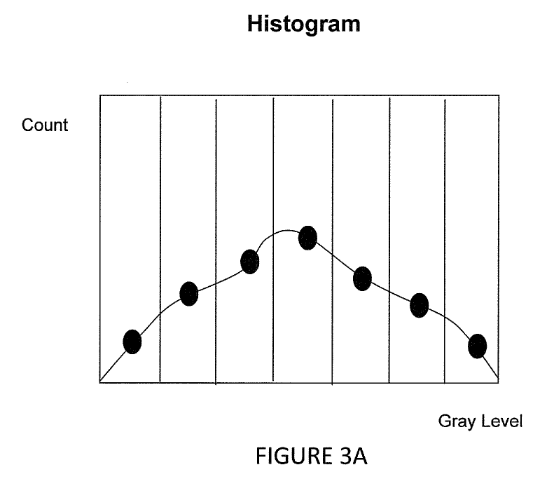

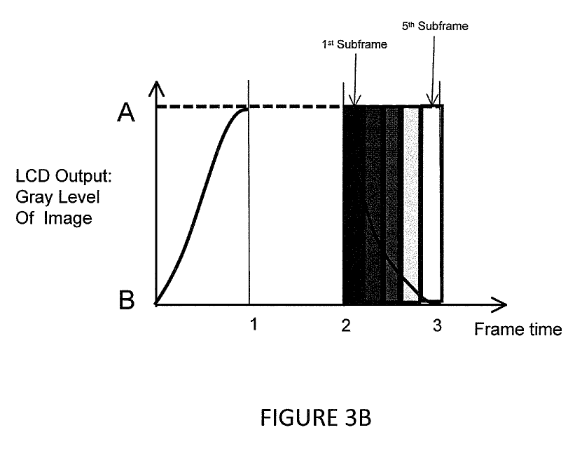

FIG. 3A is a histogram of gray levels based on image data obtained for one frame of data, in accordance with an embodiment of the invention. A histogram may be described in terms of n bins or intervals where the independent variable is mapped on the abscissa or x-axis while the dependent variable is mapped on the ordinate or y-axis. In the representative embodiment shown in FIG. 3A, the x-axis plots gray level while the number of pixels associated with a bin or interval (i.e., frequency or count) is mapped on the ordinate or y-axis. In the sample histogram shown in FIG. 3A, n=7. Thus, there are 7 bins or intervals representing 7 gray levels. Each of the 7 gray levels may comprise the average gray level value associated with that interval. Thus, for a histogram comprising n intervals, each of the n intervals represents an average gray level value associated with that interval. In the representative embodiment of FIG. 3A, the x-axis plots gray level while the y-axis plots the number of pixels for a particular gray level interval or bin. In another representative embodiment, the number of gray level intervals in the histogram, n, may differ from n=7. The frequency or count may be used as a factor to determine whether its associated gray level will be used in modulating a corresponding subframe of a particular frame. For example, if a count is very low, the backlight control circuitry may determine that the gray level associated with the count should not be used in modulating the backlight light source circuitry for a particular subframe. In a representative embodiment, a frame is divided into a number of subframes such that the backlight associated with each subframe may be controlled individually. For example, if it is determined that 5 different gray levels of a histogram are to be used, the backlight associated with each of 5 subframes would be modulated using the gray level associated with that subframe. The appropriate gray level used to modulate an n^{th} subframe is found by choosing the gray level associated with the n^{th} interval of its corresponding histogram.

FIG. 3B is a graph of a liquid crystal display's (LCD's) response time during a gray level transition as a function of frame time. FIG. 3B illustrates how a single frame (i.e., illustrated in FIG. 3B as between frame time 2 and 3) may be divided into subframes, thereby allowing the backlight of each subframe to be modulated within each subframe. The graph illustrates a liquid crystal display's (LCD's) response time when a gray level transition occurs between gray levels. As illustrated, the response time suffers. In a representative embodiment, a frame is divided into n subframes in which the backlight associated with each of the n subframes is individually modulated. For example, the third frame (between frame times 2 and 3, as shown) has been temporally divided into 5 subframes. As shown, the first subframe and the fifth subframe are indicated on the graph of FIG. 3B. While the embodiment of FIG. 3B illustrates a frame divided by n=5, in other embodiments, n may be configured to be any integer greater than 1. The value of n may be determined based on the number of intervals used in a histogram. Various aspects of the invention allow individual backlight control for each of n subframes. For example, the backlight for each of the 5 subframes in the embodiment shown in FIG. 3B may be adjusted or controlled for each individual subframe. Each individual subframe may be modulated based on a gray level value obtained from an interval of a histogram. In a representative embodiment, the gray level for the n^{th} subframe is obtained from the n^{th} interval of a histogram of gray levels for an image. Thus, the n^{th} subframe is modulated by the gray level specified by the n^{th} interval of the histogram. For example, in the case where n=4 and with the histogram providing gray levels that span a range between 0 and 256, there would be 4 intervals representing gray level values 32, 96, 160, 224, respectively. Thus, each of the subframes is modulated based on a value corresponding to an interval of a histogram. In a representative embodiment, the backlight is increased as n increases for a particular frame. As n increases, the response time inadequacies of the liquid crystal display become pronounced; therefore, the backlight is increased to reduce visible artifacts.

In accordance with the various aspects of the invention, the backlight control circuitry generates the modulation signal such that the backlight luminance of a frame, Lₜₒₜₐₗ, is equal to the sum of the luminances of its subframes.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

What is claimed is:

1. A method for controlling the backlight of a display comprising:
receiving an image contained in one frame of data; and
generating a histogram of said image, wherein an independent variable of said histogram comprises gray level and a dependent variable of said histogram comprises the number of pixels associated with said gray level, and wherein an average value associated with each of a plurality of gray level intervals of said histogram is used to modulate the luminance of said backlight for a subframe of a plurality of subframes of said one frame.

2. The method of claim 1 wherein the number of said plurality of subframes of said one frame is equal to the number of said plurality of gray level intervals.

3. The method of claim 1 wherein said one frame has luminance equal to the sum of each of the subframe luminances of said plurality of subframes.

4. The method of claim 1 wherein said luminance of said backlight is modulated using a pulse width modulation (PWM) signal.

5. The method of claim 4 wherein a duty cycle of said PWM signal controls said luminance.

6. The method of claim 1 wherein said frame has refresh rate of 120 Hz.

7. The method of claim 1 wherein said frame has refresh rate of 240 Hz.

8. The method of claim 1 wherein said frame has refresh rate of 360 Hz or higher.

9. The method of claim 1 wherein said display comprises a liquid crystal display (LCD) television set.

10. The method of claim 1 wherein said display comprises a liquid crystal display (LCD) computer monitor.

11. A system for controlling the backlight in a display comprising:
one or more circuits operable for, at least:
receiving an image contained in one frame of data; and
generating a histogram of said image, wherein an independent variable of said histogram comprises gray level and a dependent variable of said histogram comprises the number of pixels associated with said gray level, and wherein an average value associated with each of a plurality of gray level intervals of said histogram is used to modulate the luminance of said backlight for a subframe of a plurality of subframes of said one frame.

12. The system of claim 11 wherein the number of said plurality of subframes in said one frame is equal to the number of said plurality of gray level intervals.

13. The system of claim 11 wherein said one frame has luminance equal to the sum of each of the subframe luminances of said plurality of subframes.

14. The system of claim 11 wherein said luminance of said backlight is modulated using a pulse width modulation (PWM) signal.

15. The system of claim 14 wherein a duty cycle of said PWM signal controls said luminance.

16. The system of claim 11 wherein said frame has refresh rate of 120 Hz.

17. The system of claim 11 wherein said frame has refresh rate of 240 Hz.

18. The system of claim 11 wherein said frame has refresh rate of 360 Hz or higher.

19. The system of claim 11 wherein said display comprises a liquid crystal display (LCD) television set.

20. The system of claim 11 wherein said display comprises a liquid crystal display (LCD) computer monitor.

21. A method for controlling the backlight in a display comprising:
receiving an image contained in one frame of data; and
generating a histogram of said image, wherein an abscissa of said histogram comprises gray level intervals and an ordinate of said histogram comprises the number of pixels associated with said gray level intervals, and wherein an average value associated with each of said gray level intervals is used to modulate the luminance of said backlight for a subframe of a plurality of subframes of said one frame.

22. The method of claim 21 wherein the number of said plurality of subframes in said one frame is equal to the number of said plurality of gray level intervals.

23. The method of claim 21 wherein said one frame has luminance equal to the sum of each of the subframe luminances of said plurality of subframes.

24. The method of claim 21 wherein said luminance of said backlight is modulated using a pulse width modulation (PWM) signal.

25. The method of claim 24 wherein a duty cycle of said PWM signal controls said luminance.

26. The method of claim 21 wherein said frame has refresh rate of 120 Hz.

27. The method of claim 21 wherein said frame has refresh rate of 240 Hz.

28. The method of claim 21 wherein said frame has refresh rate of 360 Hz or higher.

29. The method of claim 21 wherein said display comprises a liquid crystal display (LCD) television set.

30. The method of claim 21 wherein said display comprises a liquid crystal display (LCD) computer monitor.
